(19) United States
(12) Patent Application Publication
(10) Pub. No.: US 2012/0006768 A1
(43) Pub. Date: Jan. 12, 2012

(54) SOLAR PANEL SUPPORT FRAMES

(76) Inventor: Dallas Kellerman, Belleville, IL (US)

(21) Appl. No.: 12/833,097

(22) Filed: Jul. 9, 2010

(51) Int. Cl. F24J 2/52; B65G 57/02

(52) U.S. Cl. 211/41.1; 414/802

(57) ABSTRACT

Solar panel mounting frame assemblies are provided, as well as methods of stacking and transporting the same. The solar panel mounting frame assemblies include a first set of bars that are located adjacent to a top surface of a second set of bars. A bottom surface of each of the bars included within the second set of bars have at least one notch, which is configured to receive a bar included within a first set of bars of a second solar panel mounting frame assembly.

### FIELD OF THE INVENTION

The field of the present invention relates to solar panel support frames and, more particularly, to devices and methods for stacking and transporting solar panel support frames.

### BACKGROUND OF THE INVENTION

Solar power has recently gained momentum as one of the leading renewable energy sources for today and beyond. Solar power is produced by converting sunlight into electricity using arrays of photovoltaics (PV)—or various other experimental technologies and materials. The arrays of photovoltaics, which are also generally referred to as “solar panels,” are typically mounted to a frame in such a way as to maximize the exposure of such arrays to sunlight. The solar panel mounting frames often span a considerable geographical area, in order to capture a sufficient amount of sunlight to efficiently generate a relevant amount of electricity. For example, in 2007, a 75-megawatt (MW) solar energy generating system was constructed near Boulder City, Nev., which includes a field of solar panels that covers approximately 300 acres.

Additional solar fields are currently under construction, and many are in the early planning stages. Given the significant amount of geographical area that these solar energy generating systems cover, a significant number of solar panel mounting frames are often needed to be transported to the site of a new solar field for assembly. These solar panel mounting frames are typically manufactured from steel and/or other rigid and heavy material, which translates into significant transportation and shipping costs.

As explained below, the present invention provides improved devices and methods for stacking solar panel support and mounting frames, which make transporting such frames safer, easier, and substantially more cost-effective.

### BRIEF DESCRIPTION OF THE FIGURES

FIG. 1 is a perspective view of several solar panel support frames stacked on each other, with the notch portions of each frame receiving a support bar of another frame, as described herein.

FIG. 2 is a side view of a notch portion and support bar of the solar panel support frames described herein.

### SUMMARY OF THE INVENTION

According to certain aspects of the present invention, solar panel mounting frame assemblies are provided. More particularly, the solar panel mounting frame assemblies comprise a first set of bars that are located adjacent to a top surface of a second set of bars. The invention provides that a bottom surface of each of the bars that comprise the second set of bars have at least one notch, which is configured to receive a bar included within a first set of bars of a second solar panel mounting frame assembly. In other words, according to certain embodiments, each solar panel mounting frame will comprise a first set/layer of bars positioned on top of a second set/layer of bars. Each solar panel mounting frame has a series of notches located at the bottom of the second set/layer of bars, whereby each notch is configured to receive a bar included within a first set/layer of bars of another solar panel mounting frame, such that successive frames may be stacked on each other in such manner, as described herein.

According to additional aspects of the present invention, methods of stacking and transporting solar panel mounting frame assemblies are provided. Such methods generally comprise placing a first solar panel mounting frame, which comprises a first set of bars that are located adjacent to a top surface of a second set of bars, on top of a second solar panel mounting frame. The invention provides that a bottom surface of each of the bars that are included within the second set of bars of the first solar panel mounting frame, will have a notch that is configured to receive a bar included within a first set of bars of the second solar panel mounting frame. According to such methods, the first solar panel mounting frame may be positioned on top of the second solar panel mounting frame, such that the notch receives the bar included within the first set of bars of the second solar panel mounting frame.

The above-mentioned and additional features of the present invention are further illustrated in the Detailed Description contained herein.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

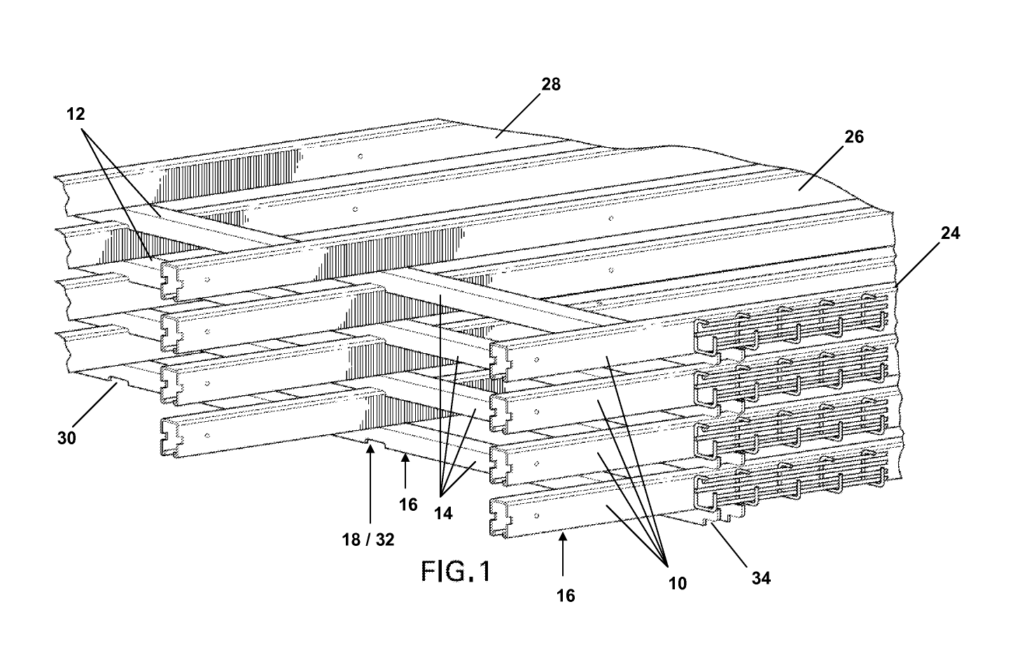

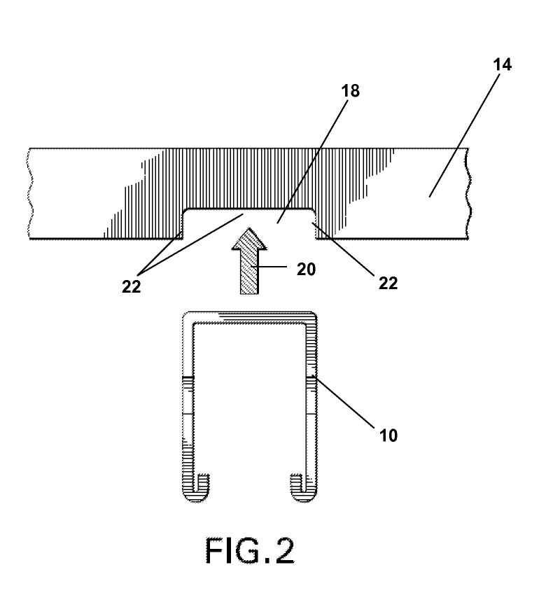

Referring to FIGS. 1 and 2, according to certain preferred embodiments of the present invention, solar panel mounting frame assemblies are provided. Each solar panel mounting frame will preferably comprise two layers of bars. For example, the solar panel mounting frame assemblies will preferably include a first set of bars 10 that are located adjacent to a top surface 12 of a second set of bars 14. The invention provides that the first set of bars 10 and second set of bars 14 may be formed as a single unit or, alternatively, may be formed separately and then welded or mechanically attached to each other. In the assembly shown in FIG. 1, for example, a set of four separate solar panel mounting frames are illustrated, with each frame having a first set of bars 10 and a second set of bars 14.

The invention provides that a bottom surface 16 of each of the bars that are included within the second set of bars 14 have at least one notch 18, which is configured to receive 20 (FIG. 2) a bar included within a first set of bars 10 of a second solar panel mounting frame assembly, as illustrated in FIGS. 1 and 2. The invention provides that, in certain preferred embodiments, the first set of bars 10 is positioned perpendicular, or approximately perpendicular, to the second set of bars 14. In certain alternative embodiments, however, the first set of bars 10 may be oriented in a way that is not perpendicular, or approximately perpendicular, to the second set of bars 14, provided that the notch 18 is configured to receive 20 a bar included within a first set of bars 10 of a second solar panel mounting frame.

As illustrated in FIG. 2, the invention provides that the notch 18 will preferably comprise three sides 22, with a 90-degree angle (or an approximately 90-degree angle) adjoining each side, which creates a rectangular cross-section. According to such embodiments, the first set of bars 10 of each solar panel mounting frame will exhibit a corresponding rectangular cross-section, such that it may be securely inserted into the notch 18. The invention provides that the second set of bars 14 of each solar panel mounting frame will preferably comprise a separate notch 18 for each bar included within first set of bars 10 of a second solar panel mounting frame assembly. For example, referring to FIG. 1, the portion of the solar panel mounting frames shown therein includes three bars 24, 26, 28 running in parallel, within the first set of bars 10. Accordingly, three separate notches 30, 32, 34 are located in the second set of bars 14, which are spaced from each other in a manner that each notch 18 is capable of receiving a bar included within the first set of bars 10 of the solar panel mounting frame stacked beneath it. The invention provides that the notch 18 that is located at the end of each bar included within the second set of bars 14 may comprise a full notch 18 (with three sides 22) or, alternatively, it may be configured as a partial notch and comprise only two sides, provided that it is configured to receive the bar of the first set of bars 10 (of another solar panel mounting frame) directly beneath the partial notch. A non-limiting example of a partial notch 34 is illustrated in FIG. 1.

Although the first set of bars 10, second set of bars 14, and notch 18 of the solar panel mounting frames shown and described herein exhibit a rectangular cross-section, the invention provides that bars and notches of other dimensions may also be employed, so long as a notch of a first solar panel mounting frame is allowed to receive a bar of a second solar panel mounting frame. For example, the invention provides that the first set of bars 10 and second set of bars 14 may be cylindrical in shape, provided that the notch 18 of the second set of bars 14 exhibits a semi-circular cross-section such that it may receive a cylindrically-shaped bar (of a second solar panel mounting frame positioned beneath it).

The invention provides that the solar panel mounting frames of the present invention may be stacked on each other, with the notch 18 of each frame allowing such frames to be stacked in a more compact manner (compared to such frames without a series of notches 18). This aspect of the invention allows a larger number of solar panel mounting frames to be shipped in a defined space (compared to such frames without the notch 18), since the frames may be stacked more closely to each other. Given the considerable weight of these frames, which are often comprised of stainless steel or other heavy materials, this translates into considerable savings on shipping costs. In addition, the invention provides that because the notch 18 of each frame receives a bar from another frame over which the notch 18 is positioned, the frame assemblies (i.e., multiple solar panel mounting frames stacked on each other) do not move and slide on each other during transportation (which does occur with prior art solar panel mounting frames that do not comprise the series of notches 18 described herein).

According to additional aspects of the present invention, methods of stacking and transporting solar panel mounting frame assemblies are provided, particularly the solar panel mounting frames described herein. More specifically, the methods of the present invention generally comprise placing a first solar panel mounting frame, which comprises a first set of bars 10 that are located adjacent to a top surface 12 of a second set of bars 14, on top of a second solar panel mounting frame. The invention provides that a bottom surface 16 of each of the bars that are included within the second set of bars 14 of the first solar panel mounting frame, will have a notch 18 that is configured to receive a bar included within a first set of bars 10 of the second solar panel mounting frame. According to such methods, the first solar panel mounting frame may be positioned on top of the second solar panel mounting frame, such that the notch 18 of the first solar panel mounting frame receives the bar included within the first set of bars 10 of the second solar panel mounting frame, as illustrated in FIGS. 1 and 2 and described further above.

Although certain example methods, apparatus, and/or articles of manufacture have been described herein, the scope of coverage of this disclosure is not limited thereto. On the contrary, this disclosure covers all methods, apparatus, and/or articles of manufacture fairly falling within the scope of the appended claims either literally or under the doctrine of equivalents.

What is claimed is:

1. A solar panel mounting frame assembly, which comprises a first set of bars that are located adjacent to a top surface of a second set of bars, wherein a bottom surface of each of the bars that comprise the second set of bars includes a notch, wherein the notch is configured to receive a bar included within a first set of bars of a second solar panel mounting frame assembly.

2. The solar panel mounting frame assembly of claim 1, wherein the first set of bars is positioned approximately perpendicular to the second set of bars.

3. The solar panel mounting frame assembly of claim 1, wherein the notch comprises three sides.

4. The solar panel mounting frame assembly of claim 3, wherein the second set of bars comprise a rectangular cross-section.

5. The solar panel mounting frame assembly of claim 1, wherein the first set of bars is positioned approximately perpendicular to the second set of bars.

6. The solar panel mounting frame assembly of claim 5, wherein the notch comprises three sides.

7. The solar panel mounting frame assembly of claim 6, wherein the second set of bars comprise a rectangular cross-section.

8. A method of stacking and transporting solar panel mounting frame assemblies, which comprises placing a first solar panel mounting frame, which comprises a first set of bars that are located adjacent to a top surface of a second set of bars, on top of a second solar panel mounting frame, wherein:
(a) a bottom surface of each of the bars that comprise the second set of bars of the first solar panel mounting frame includes a notch that is configured to receive a bar included within a first set of bars of the second solar panel mounting frame; and
(b) the first solar panel mounting frame is positioned on top of the second solar panel mounting frame such that the notch receives the bar included within the first set of bars of the second solar panel mounting frame.

9. The method of claim 8, wherein the first set of bars of the first solar panel mounting frame is positioned approximately perpendicular to the second set of bars of the first solar panel mounting frame.

10. The method of claim 8, wherein the notch comprises three sides.

11. The method of claim 10, wherein the first set of bars and second set of bars of the first solar panel mounting frame and the second solar panel mounting frame comprise a rectangular cross-section.
